(19) United States
(12) Patent Application Publication
(10) Pub. No.: US 2014/0119335 A1
(43) Pub. Date: May 1, 2014

(54) METHOD FOR TRANSMITTING DOWNLINK CONTROL SIGNALING, METHOD FOR SEARCHING DOWNLINK CONTROL SIGNALING AND APPARATUS USED FOR THE SAME

(71) Applicant: FUJITSU LIMITED, Kawasaki-shi (JP)

(72) Inventors: Yi WANG, Beijing (CN); Yuantao ZHANG, Beijing (CN); Hua ZHOU, Beijing (CN)

(73) Assignee: FUJITSU LIMITED, Kawasaki-shi (JP)

(21) Appl. No.: 14/146,437

(22) Filed: Jan. 2, 2014

Related U.S. Application Data
(63) Continuation of application No. PCT/CN2011/077181, filed on Jul. 15, 2011.

(51) Int. Cl. H04W 72/04

(52) U.S. Cl. CPC H04W 72/042
USPC 370/330; 370/329

(57) ABSTRACT

Embodiments of the present invention provide a method for transmitting downlink control signaling, a method for searching downlink control signaling and an apparatus used for the same. The method for transmitting includes: transmitting downlink control information (DCI) in a common search space of a control region of a wireless communications system, the DCI indicating a search space of a UE-specific physical downlink control channel (PDCCH) located in a data region of the wireless communications system, the DCI further including a predetermined identifier for identifying the DCI. With the methods and apparatuses of the embodiments of the present invention, the search space of the PDCCH may be dynamically adjusted, thereby saving signaling overhead, and avoiding inconsistence of the search space of the base station and that of the UE.

### CROSS-REFERENCE TO RELATED APPLICATIONS

This is a continuation of International Application No. PCT/CN2011/077181, filed on Jul. 15, 2011, now pending, the contents of which are herein wholly incorporated by reference.

### TECHNICAL FIELD

The present invention relates to a transmission technology in a wireless communications system, and in particular to a method for transmitting downlink control signaling, a method for searching downlink control signaling and an apparatus used for the same.

### BACKGROUND ART

In a long-term evolution (LTE) system, various downlink control information (DCI) is transmitted in a form of a physical downlink control channel (PDCCH) by a base station, and data is transmitted in a form of a physical downlink shared channel (PDSCH) by the base station. PDCCHs and PDSCHs are present in each subframe in a time-division form. As shown in FIG. 1, the first to N-th orthogonal frequency division multiplexing (OFDM) symbols are possible transmission regions of the PDCCHs, N=1, 2, 3 or 4, which are configured via high layer signaling; and OFDM symbols starting from the (N+1)-th OFDM symbol are transmission regions of the PDSCHs.

A PDCCH supports spatial diversity multi-antenna transmission based on a cell-specific reference signal (CRS), with the maximum number of transmission antennas being 4. The PDCCH regions are further divided into a common search space and a UE-specific search space. Common search spaces of all UE (User Equipment) are identical, and all the UE searches their own PDCCHs in an identical space. While the UE-specific search space is related to a radio network temporary identifier (RNTI) of the UE, and each of the UE searches its own PDCCHs in its own space.

In order to increase a data transmission rate and improve a spectral efficiency, multi-antenna is widely used in wireless communications systems. In an LTE-advanced system, a downlink may support up to 8 transmission antennas, so as to achieve a transmission rate of 1 Gbps. A PDSCH may not only increase the transmission rate but also expand the coverage of a signal by precoding and beamforming. While a PDCCH does not support 8-antenna transmission yet, and supports only a transmission diversity of at most 4 antennas, and hence cannot obtain the same beamforming gain as that of the PDSCH.

In order to further improve the performance of cell-edge UE, a coordinated multi-point transmission technology based on a network architecture of multiple geographically spaced remote radio headers (RRHs) will be widely used in a future wireless communications system. In such a network architecture of multiple RRHs, a cell splitting gain is obtained by simultaneously scheduling PDSCHs of the UE within the coverage of the RRHs, so as to increase the capacity of a cell. And at the same time, the capacity of a cell may also be increased by space multiplexing PDSCH of multiple pieces of UE. As an existing PDCCH based on a CRS cannot obtain a cell splitting gain, attention has been focused on the study of a PDCCH based on a demodulation reference signal (DM-RS), intended to expand the PDCCH from conventional former N OFDM symbols to other regions. However, how to notify UE of a position of its new PDCCH search space is an urgent problem.

It should be noted that the above description of the background art is merely provided for clear and complete explanation of the present invention and for easy understanding by those skilled in the art. And it should not be understood that the above technical solution is known to those skilled in the art as it is described in the background art of the present invention.

### SUMMARY OF THE INVENTION

An object of the embodiments of the present invention is to provide a method and an apparatus for transmitting downlink control signaling, wherein newly-defined DCI is transmitted in a common search space of a conventional PDCCH region, so as to dynamically indicate information on a new PDCCH search space of UE.

According to one aspect of the embodiments of the present invention, there is provided a method for transmitting downlink control signaling, and the method includes:

transmitting, by a base station, downlink control information (DCI) in a common search space of a control region of a wireless communications system, the DCI indicating a search space of a UE-specific physical downlink control channel (PDCCH) located in a data region of the wireless communications system;

and the DCI further including a predetermined identifier for identifying the DCI.

According to another aspect of the embodiments of the present invention, there is provided a method for searching downlink control signaling, and the method includes:

determining, by user equipment (UE), whether a search space of a UE-specific physical downlink control channel (PDCCH) is to be transmitted in a control region of a wireless communications system or in a data region of the wireless communications system;

searching, by the UE, downlink control information (DCI) in a common search space of the control region of the wireless communications system, and decoding the DCI, if the search space of the UE-specific PDCCH is transmitted in the data region of the wireless communications system; and

searching, by the UE, a UE-specific PDCCH that includes physical downlink shared channel (PDSCH) scheduling or physical uplink shared channel (PUSCH) scheduling, according to the search space of the PDCCH located in the data region of the wireless communication system indicated by the DCI.

According to a further aspect of the embodiments of the present invention, there is provided a base station, and the base station includes:

a transmitting unit configured to transmit downlink control information (DCI) in a common search space of a control region of a wireless communications system, the DCI indicating a search space of a UE-specific physical downlink control channel (PDCCH) located in a data region of the wireless communications system;

and the DCI further including a predetermined identifier for identifying the DCI.

According to still another aspect of the embodiments of the present invention, there is provided user equipment (UE), and the UE includes:

a determining unit configured to determine whether a search space of a UE-specific physical downlink control channel (PDCCH) is to be transmitted in a control region of a wireless communications system or in a data region of the wireless communications system;

a decoding unit configured to search downlink control information (DCI) in a common search space of the control region of the wireless communications system, and to decode the DCI, when it is determined by the determining unit that the search space of the UE-specific PDCCH is transmitted in the data region of the wireless communications system; and

a reading unit configured to search a UE-specific PDCCH that includes physical downlink shared channel (PDSCH) scheduling or physical uplink shared channel (PUSCH) scheduling, according to the search space of the PDCCH located in the data region of the wireless communication system indicated by the DCI obtained by the decoding unit by decoding.

According to still another aspect of the embodiments of the present invention, there is provided a computer readable program, wherein when the program is executed in a base station, the program enables a computer to execute the method for transmitting downlink control signaling as described above in the base station.

According to still another aspect of the embodiments of the present invention, there is provided a storage medium in which a computer-readable program is stored, wherein the computer-readable program enables a computer to execute the method for transmitting downlink control signaling as described above in a base station.

According to still another aspect of the embodiments of the present invention, there is provided a computer readable program, wherein when the program is executed in user equipment, the program enables a computer to execute the method for searching downlink control signaling as described above in the user equipment.

According to still another aspect of the embodiments of the present invention, there is provided a storage medium in which a computer-readable program is stored, wherein the computer-readable program enables a computer to execute the method for searching downlink control signaling as described above in user equipment.

The advantage of the embodiments of the present invention exists in that information on a new PDCCH search space of UE may be dynamically indicated by transmitting newly-defined DCI in a common search space of a conventional PDCCH region. With such a solution, a PDCCH search space may be dynamically adjusted, signaling overhead may be saved, and inconsistence of a search space of a base station and that of UE may be avoided.

With reference to the following description and drawings, the particular embodiments of the present invention are disclosed in detail, and the principle of the present invention and the manners of use are indicated. It should be understood that the scope of the embodiments of the present invention is not limited thereto. The embodiments of the present invention contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment. In the drawings:

FIG. 1 is a schematic diagram of transmission regions of PDCCH/PDSCH in an LTE system;

FIG. 2 is a schematic diagram of transmission regions of PDCCH/PDSCH of an embodiment of the present invention;

FIG. 3 is a flowchart of a method for transmitting downlink control signaling of an embodiment of the present invention;

FIG. 4 is a schematic diagram of setting of a newly-defined DCI identification bit of an embodiment of the present invention;

FIG. 5 is a flowchart of a method for searching downlink control signaling provided by an embodiment of the present invention;

FIG. 6a is a schematic diagram of DCI payload in which the DCI comprising only offset information of a search space;

FIG. 6b is a schematic diagram of DCI payload in which the DCI comprising time-frequency resource allocation information and offset information of a search space;

FIG. 7 is a schematic diagram of the structure of a base station provided by an embodiment of the present invention; and

FIG. 8 is a schematic diagram of the structure of user equipment provided by an embodiment of the present invention.

### DETAILED DESCRIPTION OF THE INVENTION

Various embodiments of the present invention shall be described below with reference to the drawings. These embodiments are illustrative only, and are not intended to limit the present invention. For easy understanding of the principle and embodiments of the present invention by those skilled in the art, the embodiments of the present invention shall be described taking a method for transmitting downlink control signaling, a method for searching downlink control signaling and an apparatus used for the same in an LTE/LTE-A system as an example. However, it should be understood that the embodiments of the present invention are not limited to said system, and are applicable to any other wireless communications system relating to transmission and search of downlink control signaling.

FIG. 2 is a schematic diagram of transmission regions of PDCCH/PDSCH of an embodiment of the present invention. As shown in FIG. 2, in the embodiment of the present invention, a search space of a PDCCH is expanded from a conventional PDCCH region, i.e. conventional former N OFDM symbols, to a PDSCH region starting from the (N+1)-th symbol, such as the new PDCCH region shown in FIG. 2. With the method of this embodiment, UE needs to obtain an exact position of the new PDCCH regions, that is, information on a subcarrier resource occupied in the frequency domain and/or an OFDM symbol occupied in the time domain, and the UE may perform blind detection in this region, so as to correctly demodulate respective PDCCHs.

### Embodiment 1

FIG. 3 is a flowchart of a method for transmitting downlink control signaling of an embodiment of the present invention. Referring to FIG. 3, the method includes:

step 301: transmitting downlink control information (DCI) in a common search space of a control region of a wireless communications system, the DCI indicating a search space of a UE-specific PDCCH located in a data region of the wireless communications system.

In step 301, the wireless communications system may be an LTE system, such as an LTE R8 system, or an LTE-A system, such as an LTE-A R-10 system; and it may also be other systems transmitting various DCI via PDCCH, and this embodiment is not limited thereto.

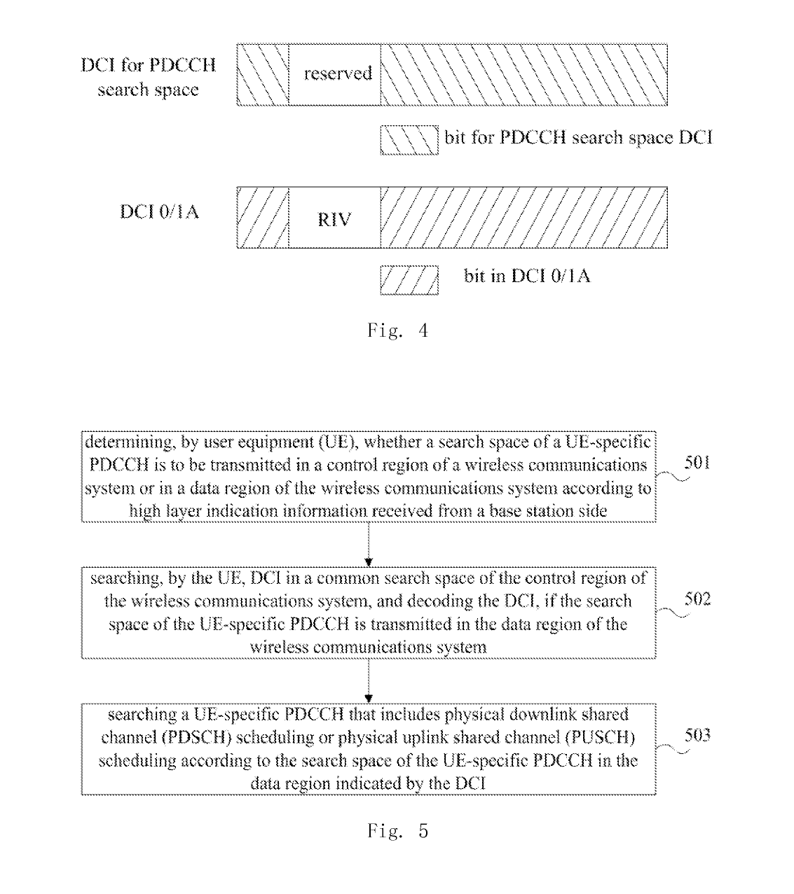

In step 301, the DCI may further include a predetermined identifier for identifying the DCI. According to the predetermined identifier, the UE may determine whether the DCI transmitted in the control region of the wireless communications system is the newly-defined DCI in the embodiment of the present invention or existing DCI;

wherein, the DCI may take a redundant bit in existing DCI as the predetermined identifier, so as to be differentiated from existing DCI, that is, in the new DCI, a predetermined bit at a position corresponding to a redundant bit in existing DCI is taken as the predetermined identifier; and a newly-defined RNTI may be taken as the predetermined identifier, so as to be differentiated from existing DCI. Preferably, the length of the newly-defined RNTI is identical to that of a CRC of the PDCCH, which may be 8 or 16 after binary addition of it and the CRC, and is allocated to multiple pieces of UE at the same time, informing the UE via high layer signaling. Preferably, an unused code point in a resource indication value (RIV) of a redundant bit in existing DCI may be taken as an identifier. For example, if the former M bits in the RIV are all 1, it indicates that the DCI is newly-defined DCI; otherwise, it indicates that the DCI is existing DCI 1/1A. As shown in FIG. 4, if ‘xxxx . . . xx’=‘11xx . . . xx’, then ‘11’ is taken as the identifier, and it indicates that the DCI is newly-defined DCI; and if ‘xxxx . . . xx’=‘01xx . . . xx’ or ‘xxxx . . . xx’=‘00xx . . . xx’ or ‘xxxx . . . xx’=‘10xx . . . xx’, it indicates that the DCI is existing DCI 1/1A, as ‘xxxx . . . xx’ is reasonable resource allocation (RA) information in the DCI 1/1A;

wherein, the existing DCI refers to DCI defined in various standards of existing wireless communications systems, which is different from the newly-defined DCI provided in the embodiments of the present invention.

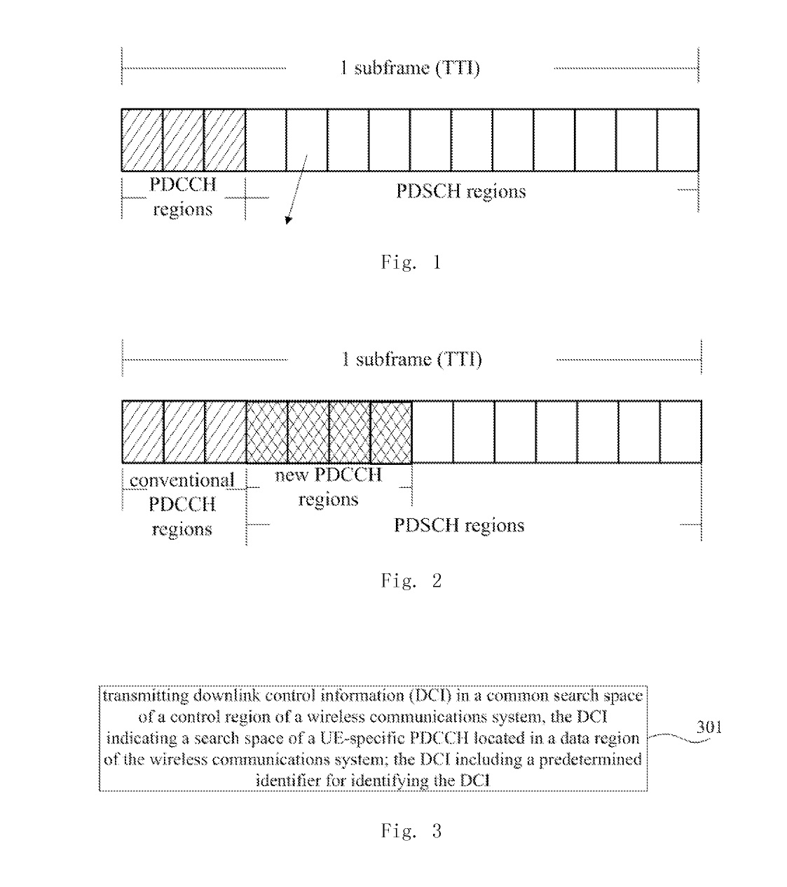

In this embodiment, the control region of the wireless communications system refers to a region for transmitting DCI in an existing wireless communications system, such as the PDCCH region shown in FIG. 1 or the conventional PDCCH region shown in FIG. 2. And the data region of the wireless communications system refers to a region for transmitting data in an existing wireless communications system, such as the PDSCH region shown in FIG. 1 or the PDSCH region shown in FIG. 2. In this embodiment, the existing DCI refers to various downlink control information in the existing wireless communications system, such as the DCI transmitted in the PDCCH region shown in FIG. 1. Relative to the existing DCI, in the method of the embodiment of the present invention, DCI indicating a search space of a UE-specific PDCCH transmitted in the data region will also be transmitted in the PDCCH region shown in FIG. 1, this DCI being the newly-defined DCI in the embodiments of the present invention. In the following description, the same definitions have the same meanings

In this embodiment, a search space of a PDCCH in the data region is indicated by the newly-defined DCI, and an exact position of the PDCCH region may be determined according to the newly-defined DCI. Following description is given by way of various embodiments.

In an embodiment, the newly-defined DCI includes time-frequency resource allocation information of the search space of the PDCCH in the data region. And an exact position of a search space of the UE-specific PDCCH can be determined by UE according to the time-frequency resource allocation information included in the newly-defined DCI;

wherein, a method for allocating the time-frequency resource is predefined, which may be fixed, or optional and be notified via high-layer signaling, so as to ensure the consistence of understanding between a base station end and a UE end. Preferably, a method for allocating the time-frequency resource may adopt type 0, type 1 or type 2 in an LTE system, and may also be a newly-defined method for allocating a time-frequency resource, and this embodiment is not limited thereto;

wherein, the time-frequency resource allocation information may be cell-specific common information, that is, all the UE in a cell share an identical search space region, may be transmission point-specific (TP-specific) common information, that is, UE served by the same transmission point share an identical search space region, and may also be coordinated multiple point set specific (CoMP set-specific) common information, that is, UE served by the same coordinated multiple point set share an identical search space region.

In another embodiment, besides the time-frequency resource allocation information of the search space of the UE-specific PDCCH in the data region, the newly-defined DCI further includes offset information of the search space. For example, preferably, besides the cell-specific search space information, the newly-defined DCI further includes TP-specific search space offset information. Preferably, besides the TP-specific search space offset information, the newly-defined DCI further includes UE-specific search space offset information. Preferably, besides the cell-specific search space information, the newly-defined DCI further includes CoMP set-specific search space offset information. Preferably, besides the CoMP set-specific search space offset information, the newly-defined DCI further includes UE-specific space offset information. And the exact position of the search space of the UE-specific PDCCH can be determined by the UE according to the time-frequency resource allocation information and the offset information of the search space included in the newly-defined DCI.

In another embodiment, the newly-defined DCI may include only offset information of a search space, wherein, preferably, the offset information is UE-specific search space offset information, or CoMP set-specific search space offset information, or TP-specific search space offset information. And the exact position of the search space of the UE-specific PDCCH can be determined by the UE according to the search space offset information included in the newly-defined DCI.

In this embodiment, the length of the newly-defined DCI may be identical to that of existing DCI 0/1A, or to that of existing DCI 1C, and whether the DCI is newly-defined DCI or existing DCI is differentiated by the above-described predetermined identifier; however, this embodiment is not limited thereto. In other embodiments, the length of the newly-defined DCI may be different from that of the existing DCI. For example, it is different from the length of the existing DCI 0/1A, and is different from the length of the existing DCI 1C. If the length of the newly-defined DCI is different from that of the existing DCI 0/1A and that of the existing DCI 1C, the above-described predetermined identifier may still be employed in this embodiment for differentiating other information. For example, the newly-defined RNTI may be employed to indicate allocating to multiple pieces of UE, etc.

In the method for transmitting downlink control signaling provided in the embodiment of the present invention, the search space of the UE-specific PDCCH in the data region is indicated by the newly-defined DCI, and the newly-defined DCI is transmitted in the common search space within the data region, so as to dynamically indicate the information on the UE-specific PDCCH search space. In this way, the UE may obtain an exact position of the UE-specific PDCCH search space, i.e. information on a subcarrier resource occupied in the frequency domain and/or an OFDM symbol occupied in the time domain, and the UE may perform blind detection in this region, so as to correctly demodulate respective PDCCH. With such a solution, a PDCCH search space may be dynamically adjusted, signaling overhead may be saved, and inconsistence of a search space of a base station and that of the UE may be avoided.

An embodiment of the present invention further provides a method for searching downlink control signaling applicable to UE, as described in Embodiment 2 below. As this method is processing at a UE end corresponding to the method of Embodiment 1, the repeated parts in this method and the method of Embodiment 1 shall not be described any further.

### Embodiment 2

FIG. 5 is a flowchart of a method for searching downlink control signaling provided by an embodiment of the present invention. Referring to FIG. 5, the method includes:

step 501: determining, by user equipment (UE), whether a search space of a UE-specific PDCCH is to be transmitted in a control region of a wireless communications system or in a data region of the wireless communications system according to high layer indication information received from a base station side;

step 502: searching, by the UE, DCI in a common search space of the control region of the wireless communications system, and decoding the DCI, if the search space of the UE-specific PDCCH is transmitted in the data region of the wireless communications system;

wherein, the UE may judge whether the searched DCI is newly-defined DCI, and if it is newly-defined DCI, the UE may obtain an exact position of the UE-specific PDCCH in the data region indicated by the newly-defined DCI by decoding the newly-defined DCI; and if the result of judgment is that the searched DCI is not newly-defined DCI, but is conventional DCI, the UE performs downlink PDSCH reception or uplink PUSCH transmission or power adjustment according to the DCI in a conventional manner;

step 503: searching a UE-specific PDCCH that includes physical downlink shared channel (PDSCH) scheduling or physical uplink shared channel (PUSCH) scheduling according to the search space of the UE-specific PDCCH in the data region indicated by the DCI;

wherein, the search space of the UE-specific PDCCH in the data region may be obtained after decoding the DCI in the common search space of the control region according to step 502, and the UE may obtain the downlink control signaling of itself by searching and demodulating the PDCCH according to the search space of the UE-specific PDCCH.

Similar to Embodiment 1, in this embodiment, the newly-defined DCI may include only the time-frequency resource allocation information of the search space of the UE-specific PDCCH in the data region, may include only the offset information of the search space, and may include both the time-frequency resource allocation information of the search space of the UE-specific PDCCH in the data region and the offset information of the search space, wherein, the time-frequency resource allocation information may be cell-specific common information, or TP-specific common information, or CoMP set-specific common information, wherein, the offset information of the search space may be TP-specific search space offset information, or UE-specific search space offset information, or CoMP set-specific search space offset information. Therefore, the newly-defined DCI in this embodiment may be read by multiple pieces of UE at the same time. Preferably, the multiple pieces of UE may be all or part of the UE in the same cell, or may be all UE of the same TP, or may be all UE of the same CoMP set.

For more clear and easy understanding of the method of this embodiment, the method for searching downlink control signaling by the UE of this embodiment shall be described taking that the newly-defined DCI includes only the time-frequency resource allocation information of the search space of the UE-specific PDCCH in the data region, includes only the offset information of the search space, and includes both the time-frequency resource allocation information of the search space of the UE-specific PDCCH in the data region and the offset information of the search space as examples.

In the case where the newly-defined DCI includes only the time-frequency resource allocation information of the search space of the UE-specific PDCCH in the data region, the UE may determine the PDCCH of itself according to the time-frequency resource allocation information and an existing search method after decoding the DCI. For example, the UE determines the UE-specific search space of itself according to the RNTI of itself and a Hash function.

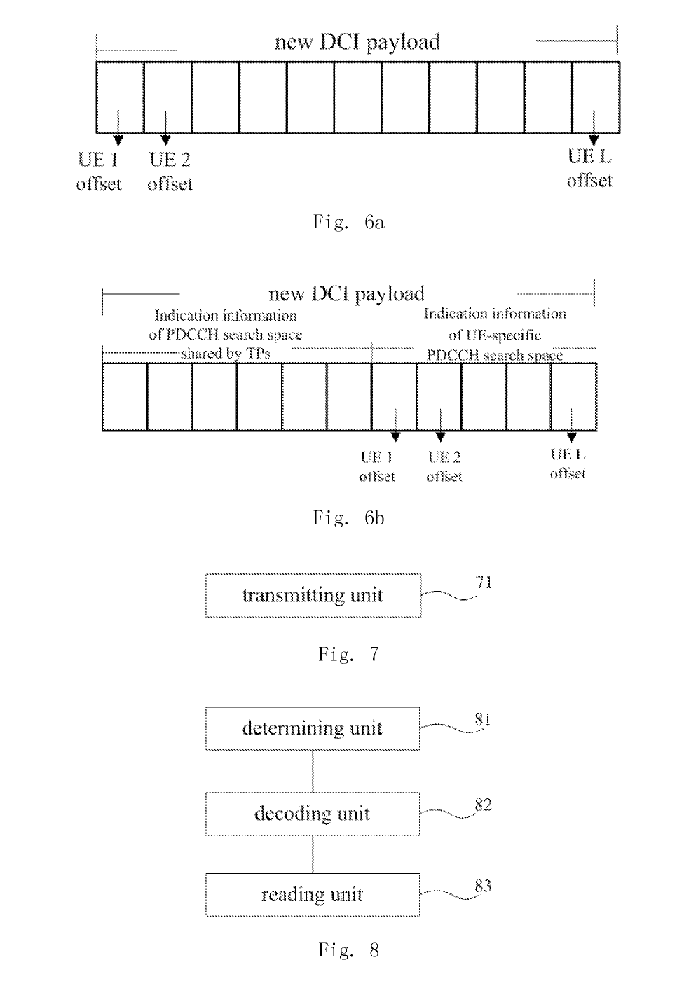

In the case where the newly-defined DCI includes only the offset information of the search space, the UE may determine the PDCCH of itself according to the information on the UE-specific PDCCH search space in the data region indicated via high-layer signaling after decoding the DCI after decoding the DCI. For example, referring to FIG. 6a, if the information on the UE-specific PDCCH search space in the data region indicated via high-layer signaling is cell-specific common information, the newly-defined DCI obtained through decoding includes only the UE-specific search space offset information, and each UE is allocated X bits for indicating the UE-specific search space offset information, totally including offset information of L UE. The UE may read respective offset information in turn according to a preconfigured order.

In the case where the newly-defined DCI includes both the time-frequency resource allocation information of the search space of the UE-specific PDCCH in the data region and the offset information of the search space, for example, referring to FIG. 6b, part of the bits of the newly-defined DCI are used to indicate the time-frequency resource allocation information of the search space of the UE-specific PDCCH in the data region shared by the TPs, and the other part of the bits are used to indicate respective offset of L UE relative to the search space shared by the TPs. The UE may read respective offset information in turn according to a preconfigured order.

With the method for searching downlink control signaling provided in this embodiment of the present invention, UE may obtain an exact position of a new PDCCH search space, i.e. information on a subcarrier resource occupied in the frequency domain and/or an OFDM symbol occupied in the time domain, and the UE may perform blind detection in this region, so as to correctly demodulate respective PDCCH. With such a solution, a PDCCH search space may be dynamically adjusted, signaling overhead may be saved, and inconsistence of a search space of a base station and that of UE may be avoided.

An embodiment of the present invention further provides a base station, as described in Embodiment 3 below. As the principle of the base station for solving problems is similar to that of the method in Embodiment 1, the implementation of the method may be referred to for the implementation of the base station, and the repeated parts shall not be described any further.

### Embodiment 3

FIG. 7 is a schematic diagram of the structure of a base station provided by an embodiment of the present invention. As shown in FIG. 7, the base station includes:

a transmitting unit 71 configured to transmit DCI in a common search space of a control region of a wireless communications system, the DCI indicating a search space of a PDCCH located in a data region of the wireless communications system; wherein, the DCI further includes a predetermined identifier for identifying the DCI, so as to be differentiated from existing DCI.

In an embodiment, the DCI transmitted by the transmitting unit 71 includes only time-frequency resource allocation information located in the search space of the UE-specific PDCCH of the data region.

In another embodiment, the DCI transmitted by the transmitting unit 71 includes only offset information of the search space.

In still another embodiment, the DCI transmitted by the transmitting unit 71 includes both the time-frequency resource allocation information located in the search space of the UE-specific PDCCH of the data region and the offset information of the search space;

wherein, the time-frequency resource allocation information may be divided into: cell-specific common information, or TP-specific common information, or CoMP set-specific common information;

wherein, the offset information of the search space may be: TP -specific search space offset information, or UE-specific search space offset information, or CoMP set-specific search space offset information.

In a further embodiment, the predetermined identifier included in the DCI transmitted by the transmitting unit 71 may be a predetermined bit in the DCI, the position of the predetermined bit in the DCI corresponding to a position of a redundant bit in existing DCI. And the predetermined identifier included in the DCI transmitted by the transmitting unit 71 may also be the RNTI.

In the base station provided in the embodiment of the present invention, the search space of the UE-specific PDCCH in the data region is indicated by the newly-defined DCI, and the newly-defined DCI is transmitted in the common search space within the control region of the wireless communications system, so as to dynamically indicate the information on the new PDCCH search space of the UE. In this way, the UE may obtain an exact position of the new PDCCH search space, i.e. information on a subcarrier resource occupied in the frequency domain and/or an OFDM symbol occupied in the time domain, and the UE may perform blind detection in this region, so as to correctly demodulate respective PDCCH. With such a solution, a PDCCH search space may be dynamically adjusted, signaling overhead may be saved, and inconsistence of a search space of a base station and that of UE may be avoided.

An embodiment of the present invention further provides user equipment (UE), as described in Embodiment 4 below. As the principle of the UE for solving problems is similar to that of the method in Embodiment 2, the implementation of the method may be referred to for the implementation of the UE, and the repeated parts shall not be described any further.

### Embodiment 4

FIG. 8 is a schematic diagram of the structure of the UE provided by an embodiment of the present invention. Referring to FIG. 8, the UE includes:

a determining unit 81 configured to determine whether a search space of a UE-specific PDCCH is to be transmitted in a control region of a wireless communications system or in a data region of the wireless communications system according to high layer indication information received from a base station side;

a decoding unit 82 configured to search DCI in a common search space of the control region of the wireless communications system, and to decode the DCI, when it is determined by the determining unit 81 that the search space of the UE-specific PDCCH is transmitted in the data region of the wireless communications system; and

a reading unit 83 configured to search a UE-specific PDCCH that includes PDSCH scheduling or PUSCH scheduling according to the search space of the UE-specific PDCCH located in the data region indicated by the DCI obtained by the decoding unit 82 by decoding.

In this embodiment, the decoding unit 82 may judge that the searched DCI is newly-defined DCI according to a predetermined identifier in the DCI, and may obtain an exact position of the search space of the UE-specific PDCCH in the data region by decoding the newly-defined DCI.

In this embodiment, the predetermined identifier in the DCI may be a predetermined bit in the DCI, the position of the predetermined bit in the DCI corresponding to a position of a redundant bit in existing DCI. And the predetermined identifier in the DCI may also be the RNTI.

In the UE provided in the embodiment of the present invention, the UE may obtain an exact position of the new PDCCH search space, i.e. information on a subcarrier resource occupied in the frequency domain and/or an OFDM symbol occupied in the time domain, and the UE may perform blind detection in this region, so as to correctly demodulate respective PDCCH. With such a solution, a PDCCH search space may be dynamically adjusted, signaling overhead may be saved, and inconsistence of a search space of a base station and that of UE may be avoided.

An embodiment of the present invention further provides a computer readable program, wherein when the program is executed in a base station, the program enables a computer to execute the method for transmitting downlink control signaling as described in Embodiment 1 in the base station.

An embodiment of the present invention further provides a storage medium in which a computer-readable program is stored, wherein the computer-readable program enables a computer to execute the method for transmitting downlink control signaling as described in Embodiment 1 in a base station.

An embodiment of the present invention further provides a computer readable program, wherein when the program is executed in user equipment, the program enables a computer to execute the method for searching downlink control signaling as described in Embodiment 3 in the user equipment.

An embodiment of the present invention further provides a storage medium in which a computer-readable program is stored, wherein the computer-readable program enables a computer to execute the method for searching downlink control signaling as described in Embodiment 3 in user equipment.

The above apparatuses and methods of the present invention may be implemented by hardware, or by hardware in combination with software. The present invention relates to such a computer-readable program that when the program is executed by a logic device, the logic device is enabled to carry out the apparatus or components as described above, or to carry out the methods or steps as described above. The present invention also relates to a storage medium for storing the above program, such as a hard disk, a floppy disk, a CD, a DVD, and a flash memory, etc.

The present invention is described above with reference to particular embodiments. However, it should be understood by those skilled in the art that such a description is illustrative only, and not intended to limit the protection scope of the present invention. Various variants and modifications may be made by those skilled in the art according to the spirits and principle of the present invention, and such variants and modifications fall within the scope of the present invention.

What is claimed is:

1. A method for transmitting downlink control signaling, comprising:
transmitting, by a base station, downlink control information (DCI) in a common search space of a control region of a wireless communications system, the DCI indicating a search space of a UE-specific physical downlink control channel (PDCCH) located in a data region of the wireless communications system;
and the DCI further including a predetermined identifier for identifying the DCI.

2. The method according to claim 1, wherein the DCI includes time-frequency resource allocation information located in the search space of the PDCCH of the data region, and/or offset information of the search space.

3. The method according to claim 2, wherein the time-frequency resource allocation information includes:
cell-specific common information; or
transmission point-specific common information; or
coordinated transmission point set-specific common information.

4. The method according to claim 2, wherein the offset information of the search space includes:
transmission point-specific search space offset information; or
UE-specific search space offset information; or
coordinated transmission point set-specific search space offset information.

5. The method according to claim 1, wherein the predetermined identifier is a predetermined bit in the DCI; alternatively, the predetermined identifier is a radio network temporary identifier (RNTI).

6. A base station, comprising:
a transmitting unit configured to transmit downlink control information DCI in a common search space of a control region of a wireless communications system, the DCI indicating a search space of a physical downlink control channel (PDCCH) located in a data region of the wireless communications system;
and the DCI further including a predetermined identifier for identifying the DCI.

7. The base station according to claim 6, wherein the DCI transmitted by the transmitting unit includes time-frequency resource allocation information located in the search space of the PDCCH of the data region, and/or offset information of the search space.

8. The base station according to claim 7, wherein,
the time-frequency resource allocation information includes: cell-specific common information, or transmission point-specific common information, or coordinated transmission point set-specific common information;
and the offset information of the search space includes: transmission point-specific search space offset information, or UE-specific search space offset information, or coordinated transmission point set-specific search space offset information.

9. The base station according to claim 6, wherein the predetermined identifier included in the DCI transmitted by the transmitting unit is a predetermined bit in the DCI; alternatively, the predetermined identifier is a radio network temporary identifier (RNTI).

10. User equipment, comprising:
a determining unit configured to determine whether a search space of a UE-specific physical downlink control channel (PDCCH) is to be transmitted in a control region of a wireless communications system or in a data region of the wireless communications system;
a decoding unit configured to search downlink control information (DCI) in a common search space of the control region of the wireless communications system, and to decode the DCI, when it is determined by the determining unit that the search space of the UE-specific PDCCH is transmitted in the data region of the wireless communications system; and
a reading unit configured to search a UE-specific PDCCH that includes physical downlink shared channel (PDSCH) scheduling or physical uplink shared channel (PUSCH) scheduling according to the search space of the PDCCH located in the data region indicated by the DCI obtained by the decoding unit by decoding.

11. The user equipment according to claim 10, wherein the decoding unit is used to determine, according to a predetermined identifier of the DCI, whether the DCI is a DCI used for indicating a search space of a UE-specific PDCCH located in the data region of the wireless communications system, and, if yes, to decode the DCI.

12. The user equipment according to claim 11, wherein the predetermined identifier of the DCI is a predetermined bit in the DCI; alternatively, the predetermined identifier of the DCI is a radio network temporary identifier (RNTI).
